(19) United States
(12) Patent Application Publication
(10) Pub. No.: US 2025/0317733 A1
(43) Pub. Date: Oct. 9, 2025

(54) METHOD FOR MANAGING READER/WRITER, TERMINAL, AND NETWORK SIDE DEVICE

(71) Applicant: VIVO MOBILE COMMUNICATION CO., LTD., Dongguan (CN)

(72) Inventor: Jinhua LIU, Dongguan (CN)

(21) Appl. No.: 19/244,126

(22) Filed: Jun. 20, 2025

Related U.S. Application Data
(63) Continuation of application No. PCT/CN2023/139917, filed on Dec. 19, 2023.

(30) Foreign Application Priority Data
Dec. 22, 2022 (CN) 202211656357.6

(51) Int. Cl. H04W 12/06; H04W 60/04; H04W 76/10

(52) U.S. Cl. CPC H04W 12/06; H04W 60/04; H04W 76/10

(57) ABSTRACT

A method for managing a reader/writer, a terminal, and a network side device are disclosed in the field of communication technologies. The method includes: sending, by an access network device, first information to an authorization device, where the first information is used to request to perform an authorization and/or authentication operation on a first reader/writer, and the first reader/writer includes a reader/writer of an ambient internet of things device; receiving, by the access network device, response information of the first information; and in a case that the response information indicates that authorization and/or authentication on the first reader/writer succeed, performing, by the access network device, a first operation related to the first reader/writer.

### CROSS-REFERENCE TO RELATED APPLICATIONS

This application is a bypass continuation application of International Application No. PCT/CN2023/139917, filed on Dec. 19, 2023, which claims the benefit of and priority to Chinese Patent Application No. 202211656357.6, filed on Dec. 22, 2022 and entitled “METHOD FOR MANAGING READER/WRITER, TERMINAL, AND NETWORK SIDE DEVICE”, the contents of both of which being incorporated reference in their entireties herein.

### TECHNICAL FIELD

This application relates to the field of communication technologies and, more specifically, relates to a method for managing a reader/writer, a terminal, and a network side device.

### BACKGROUND

The Ambient Internet of Things (Ambient IoT), also known as the Ambient Power-Enabled Internet of Things, is an emerging IoT technology currently under study by the 3rd Generation Partnership Project (3GPP).

Devices operating within the Ambient IoT framework are characterized by ultra-low complexity and extremely low power consumption. These devices typically rely on energy harvesting for power, meaning they either operate without a battery or with minimal energy storage, such as a single capacitor. Common energy sources for harvesting include radio waves, light, motion, heat, and so forth.

A reader/writer-based Ambient IoT device system can be integrated into a 3GPP network.

### BRIEF SUMMARY

Embodiments of this application provide a method for managing a reader/writer, a terminal, and a network side device.

According to a first aspect, a method for managing a reader/writer is provided, including: sending, by an access network device, first information to an authorization device, where the first information is used to request to perform an authorization and/or authentication operation on a first reader/writer, and the first reader/writer includes a reader/writer of an ambient internet of things device; receiving, by the access network device, response information of the first information; and in a case that the response information indicates that authorization and/or authentication on the first reader/writer succeed, performing, by the access network device, a first operation related to the first reader/writer.

According to a second aspect, a method for managing a reader/writer is provided, including: receiving, by an authorization device, first information from an access network device, where the first information is used to request to perform an authorization and/or authentication operation on a first reader/writer, and the first reader/writer includes a reader/writer of an ambient internet of things device; performing, by the authorization device, the authorization and/or authentication operation on the first reader/writer based on the first information, and generating response information; and sending, by the authorization device, the response information to the access network device.

According to a third aspect, a method for managing a reader/writer is provided, including: sending, by a first reader/writer, third information to an access network device, where the third information is used for at least one of the following: reporting capability information of reading/writing an ambient internet of things device; reporting identifier information of the first reader/writer; requesting to configure a wireless resource configuration used for performing an operation on the ambient internet of things device; and requesting to perform an operation on the ambient internet of things device.

According to a fourth aspect, an apparatus for managing a reader/writer is provided, including: a sending module, configured to send first information to an authorization device, where the first information is used to request to perform an authorization and/or authentication operation on a first reader/writer, and the first reader/writer includes a reader/writer of an ambient internet of things device; a receiving module, configured to receive response information of the first information; and a processing module, configured to: in a case that the response information indicates that authorization and/or authentication on the first reader/writer succeed, perform a first operation related to the first reader/writer.

According to a fifth aspect, an apparatus for managing a reader/writer is provided, including: a receiving module, configured to receive first information from an access network device, where the first information is used to request to perform an authorization and/or authentication operation on a first reader/writer, and the first reader/writer includes a reader/writer of an ambient internet of things device; a processing module, configured to: perform the authorization and/or authentication operation on the first reader/writer based on the first information, and generate response information; and a sending module, configured to send the response information to the access network device.

According to a sixth aspect, an apparatus for managing a reader/writer is provided, including: a sending module, configured to send third information to an access network device, where the third information is used for at least one of the following: reporting capability information of reading/writing an ambient internet of things device; reporting identifier information of the apparatus; requesting to configure a wireless resource configuration used for performing an operation on the ambient internet of things device; and requesting to perform an operation on the ambient internet of things device.

According to a seventh aspect, a terminal is provided. The terminal includes a processor and a memory. The memory stores a program or instructions capable of running on the processor, and when the program or the instructions are executed by the processor, the steps of the method according to the third aspect are implemented.

According to an eighth aspect, a terminal is provided, including a processor and a communication interface. The communication interface is configured to send third information to an access network device, where the third information is used for at least one of the following: reporting capability information of reading/writing an ambient internet of things device; reporting identifier information of the terminal; requesting to configure a wireless resource configuration used for performing an operation on the ambient internet of things device; and requesting to perform an operation on the ambient internet of things device.

According to a ninth aspect, a network side device is provided. The network side device includes a processor and a memory. The memory stores a program or instructions capable of running on the processor, and when the program or the instructions are executed by the processor, the steps of the method according to the first aspect or the second aspect are implemented.

According to a tenth aspect, a network side device is provided, including a processor and a communication interface. The communication interface is configured to send first information to an authorization device, where the first information is used to request to perform an authorization and/or authentication operation on a first reader/writer, and the first reader/writer includes a reader/writer of an ambient internet of things device; the communication interface is configured to receive response information of the first information; and the processor is configured to: in a case that the response information indicates that authorization and/or authentication on the first reader/writer succeed, perform a first operation related to the first reader/writer. Alternatively, the communication interface is configured to receive first information from an access network device, where the first information is used to request to perform an authorization and/or authentication operation on a first reader/writer, and the first reader/writer includes a reader/writer of an ambient internet of things device; the processor is configured to: perform the authorization and/or authentication operation on the first reader/writer based on the first information, and generate response information; and the communication interface is configured to send the response information to the access network device.

According to an eleventh aspect, a system for managing a reader/writer is provided, including a terminal and a network side device. The terminal may be configured to perform the steps of the method according to the third aspect, and the network side device may be configured to perform the steps of the method according to the first aspect or the second aspect.

According to a twelfth aspect, a readable storage medium is provided. The readable storage medium stores a program or instructions, and when the program or the instructions are executed by a processor, the steps of the method according to any one of the first aspect to the third aspect are implemented.

According to a thirteenth aspect, a chip is provided. The chip includes a processor and a communication interface. The communication interface is coupled to the processor. The processor is configured to run a program or instructions to implement the steps of the method according to any one of the first aspect to the third aspect.

According to a fourteenth aspect, a computer program/program product is provided. The computer program/program product is stored in a storage medium. The computer program/program product is executed by at least one processor to implement the steps of the method according to any one of the first aspect to the third aspect.

### BRIEF DESCRIPTION OF DRAWINGS

FIG. 1 is a schematic diagram of a wireless communication system according to an embodiment of this application;

FIG. 2 is a schematic flowchart of a method for managing a reader/writer according to an embodiment of this application;

FIG. 3 is a schematic flowchart of a method for managing a reader/writer according to an embodiment of this application;

FIG. 4 is a schematic flowchart of a method for managing a reader/writer according to an embodiment of this application;

FIG. 5 is a schematic flowchart of a method for managing a reader/writer according to an embodiment of this application;

FIG. 6 is a schematic flowchart of a method for managing a reader/writer according to an embodiment of this application;

FIG. 7 is a schematic flowchart of a method for managing a reader/writer according to an embodiment of this application;

FIG. 8 is a schematic flowchart of a method for managing a reader/writer according to an embodiment of this application;

FIG. 9 is a schematic diagram of a structure of an apparatus for managing a reader/writer according to an embodiment of this application;

FIG. 10 is a schematic diagram of a structure of an apparatus for managing a reader/writer according to an embodiment of this application;

FIG. 11 is a schematic diagram of a structure of an apparatus for managing a reader/writer according to an embodiment of this application;

FIG. 12 is a schematic diagram of a structure of a communication device according to an embodiment of this application;

FIG. 13 is a schematic diagram of a structure of a terminal according to an embodiment of this application;

FIG. 14 is a schematic diagram of a structure of a network side device according to an embodiment of this application; and

FIG. 15 is a schematic diagram of a structure of a network side device according to an embodiment of this application.

### DETAILED DESCRIPTION

The following clearly describes technical solutions in embodiments of this application with reference to accompanying drawings in the embodiments of this application. Understandably, the described embodiments are merely some rather than all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specified order or sequence. It should be understood that, terms used in this way may be interchangeable under appropriate circumstances, so that the embodiments of this application can be implemented in an order other than that illustrated or described herein. Moreover, the terms “first” and “second” typically distinguish between objects of one category rather than limiting a quantity of objects. For example, a first object may be one object or a plurality of objects. In addition, in the specification and claims, “and/or” represents at least one of connected objects, and the character “/” generally represents an “or” relationship between associated objects.

It should be noted that, a technology described in the embodiments of this application is not limited to a long term evolution (LTE)/LTE-advanced (LTE-A) system, and may be further applied to other wireless communication systems, such as a code division multiple access (CDMA) system, a time division multiple access (TDMA) system, a frequency division multiple access (FDMA) system, an orthogonal frequency division multiple access (OFDMA) system, a single-carrier frequency division multiple access (SC-FDMA) system, and another system. The terms “system” and “network” are often used interchangeably in the embodiments of this application. The technology described may be used for the systems and radio technologies described above, as well as other systems and radio technologies. The following describes a new radio (NR) system for illustrative purposes, and NR terms are used in most of the following descriptions. However, these technologies are also applicable to applications such as a 6th generation (6G) communication system other than NR system applications.

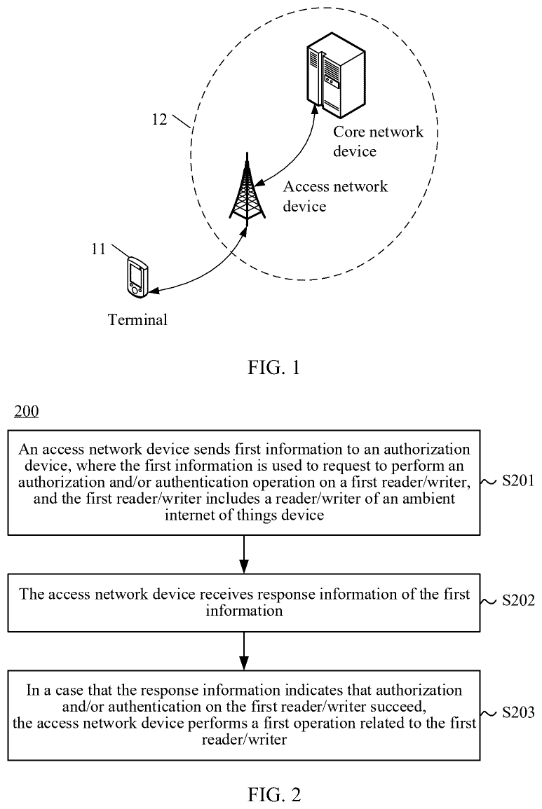

FIG. 1 is a block diagram of a wireless communication system applicable to an embodiment of this application. The wireless communication system includes a terminal (or referred to as user equipment) 11 and a network side device 12. The terminal 11 may be a mobile phone, a tablet personal computer, a laptop computer that is alternatively referred to as a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), a smart home (a home device with a wireless communication function, such as a refrigerator, a television, a washing machine, or furniture), a game console, a personal computer (PC), a teller machine, a self-service machine, or another terminal side device. The wearable device includes a smartwatch, a smart band, a smart headset, smart glasses, smart jewelry (a smart wristlet, a smart bracelet, a smart ring, a smart necklace, a smart anklet, a smart leglet, or the like), a smart wristband, a smart dress, or the like. It should be noted that a specific type of the terminal 11 is not limited in this embodiment of this application. The network side device 12 may include an access network device or a core network device. The access network device may also be referred to as a radio access network device, a radio access network (RAN), a radio access network function, or a radio access network unit. The access network device may include a base station, a WLAN access point, a WiFi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmitting receiving point (TRP), or another appropriate term in the field. The base station is not limited to a specific technical term provided that a same technical effect is achieved. It should be noted that in this embodiment of this application, only a base station in an NR system is used as an example for description, and a specific type of the base station is not limited. The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF) unit, an edge application server discovery function (EASDF), unified data management (UDM), a unified data repository (UDR), a home subscriber server (HSS), a centralized network configuration (CNC), a network repository function (NRF), a network exposure function (NEF), a local NEF (L-NEF), a binding support function (BSF), an application function (AF), and the like. It should be noted that in this embodiment of this application, only a core network device in the NR system is used as an example for description, and a specific type of the core network device is not limited.

A method for managing a reader/writer in embodiments of this application is described below in detail with reference to accompanying drawings by using some embodiments and application scenarios thereof.

As shown in FIG. 2, an embodiment of this application provides a method 200 for managing a reader/writer. The method may be performed by an access network device. In other words, the method may be performed by software or hardware installed in the access network device. The method includes the following steps.

S201: The access network device sends first information to an authorization device, where the first information is used to request to perform an authorization and/or authentication operation on a first reader/writer, and the first reader/writer includes a reader/writer of an ambient internet of things device.

In embodiments of this application, the access network device may be a base station, a WLAN access point, a WiFi node, or the like.

The authorization device may be a core network device having an authorization and authentication function for a reader/writer, such as an access and mobility management function (AMF). The authorization device may alternatively be an operator device having an authorization and authentication function for a reader/writer, such as an operation administration and maintenance (OAM) device.

The reader/writer (including the first reader/writer) may be a handheld terminal, or may be a fixedly deployed or movably deployed reading/writing device unit. An involved ambient internet of things device (Ambient IoT device) may be a passive communication-based terminal device, or may be an active communication-based terminal device. Communication between the reader/writer and the ambient internet of things device may be based on a backscatter communication mechanism, or may be based on an active communication manner in which the ambient internet of things device itself generates a transmit wave.

Optionally, before S201, the access network device (for example, a base station) may further interact with the first reader/writer. For example, in a process of accessing the base station, the first reader/writer indicates an identity of being a reader/writer to the base station. For another example, the first reader/writer initiates a wireless access procedure to the base station as a common terminal to establish a wireless connection. For still another example, the first reader/writer sends request information to the base station, requests to perform an operation (for example, a read/write operation) on the ambient internet of things device, and requests to configure a wireless transmission resource configuration between the first reader/writer and the ambient internet of things device.

S202: The access network device receives response information of the first information.

In this embodiment, after receiving the first information, the authorization device may perform an authorization and/or authentication operation on the first reader/writer based on the first information, and generate the response information. For example, the authorization device performs an authorization and authentication operation on the first reader/writer based on the first information.

Optionally, the response information includes at least one of the following:
(1) Whether the first reader/writer is authorized to perform an operation on the ambient internet of things device. In this embodiment, the response information may be: the first reader/writer is allowed to perform an operation on the ambient internet of things device. In another embodiment, the response information may be: the first reader/writer is refused to perform an operation on the ambient internet of things device.
(2) A type of an operation that the first reader/writer is authorized to perform on the ambient internet of things device, where the type of the operation includes, for example, inventory, read, lock/unlock, write, erase, and kill.
(3) A type of a target ambient internet of things device that the first reader/writer is allowed to perform an operation on, where the target ambient internet of things device may be an ambient internet of things device of a specific type, or may be a specific ambient internet of things device.

S203: In a case that the response information indicates that authorization and/or authentication on the first reader/writer succeed, the access network device performs a first operation related to the first reader/writer.

Optionally, the first operation is related to a read/write operation between the first reader/writer and the ambient internet of things device.

Optionally, that the access network device performs the first operation related to the first reader/writer includes: The access network device configures a wireless resource configuration and/or a transmission configuration of the first reader/writer.

The wireless resource configuration is used for wireless transmission between the first reader/writer and the ambient internet of things device.

The transmission configuration is used for data transmission between the first reader/writer, the access network device, and a core network device, and the data is related to the ambient internet of things device. In some examples, the transmission configuration may be further used for management of transmission quality between the access network device and the core network device.

According to the method for managing a reader/writer provided in this embodiment of this application, the access network device sends the first information to the authorization device to request to perform the authorization and/or authentication operation on the first reader/writer, where the first reader/writer includes the reader/writer of the ambient internet of things device; the access network device receives the response information of the first information; and in a case that the response information indicates that authorization and/or authentication on the first reader/writer succeed, the access network device performs the first operation related to the first reader/writer. In this embodiment of this application, it can be ensured that only an authorized and authenticated reader/writer can perform a read/write operation on the ambient internet of things device, so that a reader/writer in a 3GPP network can perform an authorized read/write operation on the ambient internet of things device, thereby improving security performance of the ambient internet of things device.

Optionally, on a basis of Embodiment 200, before the access network device sends the first information to the authorization device, the method further includes: The access network device receives second information from the first reader/writer, where the second information includes a reader/writer identity indication of the first reader/writer; and the access network device determines an AMF that supports authentication and authentication on the reader/writer, where the authorization device includes the AMF determined by the access network device.

In this embodiment, in an initial access process of the first reader/writer, the access network device initiates an authorization and authentication procedure for the first reader/writer based on the identity indication of the first reader/writer. For details, reference may be made to Embodiment 1 below.

Optionally, on a basis of Embodiment 200, before the access network device sends the first information to the authorization device, the method further includes: The access network device establishes a wireless connection to the first reader/writer based on a wireless access procedure initiated by the first read/write device, where the first information is carried in a first message, and the first message is a message in a registration process of the first reader/writer. Optionally, the first message may be an initial user equipment message, and the authorization device includes an AMF.

Optionally, the response information may be authorization information, and the response information may be carried in a user equipment context setup message.

In this embodiment, the first reader/writer registers as a common terminal, and the AMF initiates an authorization and authentication procedure for the reader/writer. For details, reference may be made to Embodiment 2 below.

Optionally, on a basis of Embodiment 200, before the access network device sends the first information to the authorization device, the method further includes: The access network device receives third information from the first reader/writer, where the third information is used for at least one of the following:
(1) reporting capability information of reading/writing the ambient internet of things device, including the foregoing operations such as inventory, read, write, erase, and kill that are performed on the ambient internet of things device;
(2) reporting identifier information of the first reader/writer, where the identifier information may be a unique identifier of the first reader/writer, or may be used to indicate that the first reader/writer is user equipment of a reader/writer type or may be used to indicate a reader/writer type of the first reader/writer, such as a reader/writer of an ambient energy storage type or a reader/writer of a passive type;
(3) requesting to configure a wireless resource configuration used for performing an operation on the ambient internet of things device, where the wireless resource configuration is used for wireless information transmission between the first reader/writer and the ambient internet of things device; and
(4) requesting to perform an operation on the ambient internet of things device.

In this embodiment, the first information sent by the access network device to the authorization device may include at least one of the following: (1) identifier information of the first reader/writer; and (2) a type of an operation that is requested to perform on the ambient internet of things device.

In this embodiment, the authorization device includes an AMF, or the authorization device includes an OAM device. For details, reference may be made to Embodiment 3 and Embodiment 4 below

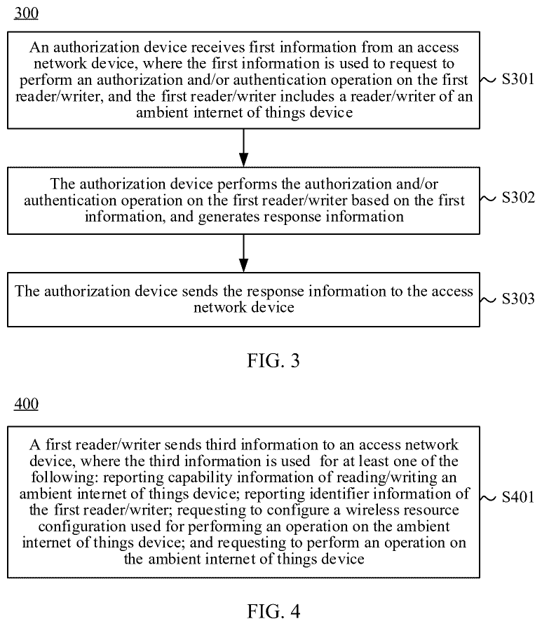

The method for managing a reader/writer according to this embodiment of this application is described in detail above with reference to FIG. 2. A method for managing a reader/writer according to another embodiment of this application is described in detail below with reference to FIG. 3. It may be understood that interaction between an authorization device and an access network device that is described from an authorization device side is the same as or corresponding to the description on an access network device side in the method shown in FIG. 2. To avoid repetition, related descriptions are appropriately omitted.

FIG. 3 is a schematic diagram of a procedure of implementing a method for managing a reader/writer according to an embodiment of this application. The method may be applied to an authorization device, such as an AMF or an OAM device. As shown in FIG. 3, the method 300 includes the following steps.

S301: The authorization device receives first information from an access network device, where the first information is used to request to perform an authorization and/or authentication operation on a first reader/writer, and the first reader/writer includes a reader/writer of an ambient internet of things device.

S302: The authorization device performs the authorization and/or authentication operation on the first reader/writer based on the first information, and generates response information.

S303: The authorization device sends the response information to the access network device.

According to the method for managing a reader/writer provided in this embodiment of this application, the authorization device receives the first information from the access network device, where the first information is used to request to perform the authorization and/or authentication operation on the first reader/writer, and the first reader/writer includes the reader/writer of the ambient internet of things device; and the authorization device performs the authorization and/or authentication operation on the first reader/writer based on the first information, generates the response information, and sends the response information to the access network device. In this embodiment of this application, it can be ensured that only an authorized and authenticated reader/writer can perform a read/write operation on the ambient internet of things device, so that a reader/writer in a 3GPP network can perform an authorized read/write operation on the ambient internet of things device, thereby improving security performance of the ambient internet of things device.

Optionally, in an embodiment, the response information includes at least one of the following:
(1) Whether the first reader/writer is authorized to perform an operation on the ambient internet of things device. In this embodiment, the response information may be: the first reader/writer is allowed to perform an operation on the ambient internet of things device. In another embodiment, the response information may be: the first reader/writer is refused to perform an operation on the ambient internet of things device.
(2) A type of an operation that the first reader/writer is authorized to perform on the ambient internet of things device. The type of the operation includes, for example, inventory, read, lock/unlock, write, erase, and kill.
(3) A type of a target ambient internet of things device that the first reader/writer is allowed to perform an operation on.

Optionally, in an embodiment, the first information includes at least one of the following: (1) identifier information of the first reader/writer; and (2) a type of an operation requested to perform on the ambient internet of things device.

Optionally, in an embodiment, the authorization device includes an AMF, or the authorization device includes an OAM device.

FIG. 4 is a schematic diagram of a procedure of implementing a method for managing a reader/writer according to an embodiment of this application. The method may be applied to a first reader/writer side. As shown in FIG. 4, the method 400 includes the following steps.

S401: A first reader/writer sends third information to an access network device, where the third information is used for at least one of the following: reporting capability information of reading/writing an ambient internet of things device; reporting identifier information of the first reader/writer; requesting to configure a wireless resource configuration used for performing an operation on the ambient internet of things device; and requesting to perform an operation on the ambient internet of things device.

According to the method for managing a reader/writer provided in this embodiment of this application, the first reader/writer sends the third information to the access network device, where the third information is used for at least one of the following: reporting the capability information of reading/writing the ambient internet of things device; reporting the identifier information of the first reader/writer; requesting to configure the wireless resource configuration used for performing an operation on the ambient internet of things device; and requesting to perform an operation on the ambient internet of things device. In this embodiment of this application, only an authorized and authenticated reader/writer can perform a read/write operation on the ambient internet of things device, so that a reader/writer in a 3GPP network can perform an authorized read/write operation on the ambient internet of things device, thereby improving security performance of the ambient internet of things device.

Optionally, in an embodiment, the method further includes: The first reader/writer receives a wireless resource configuration and/or a transmission configuration, where the wireless resource configuration is used for wireless transmission between the first reader/writer and the ambient internet of things device, the transmission configuration is used for data transmission between the first reader/writer, the access network device, and a core network device, and the data is related to the ambient internet of things device.

To describe in detail the method for managing a reader/writer provided in the embodiments of this application, the following describes the method for managing a reader/writer with reference to several specific embodiments.

### Embodiment 1

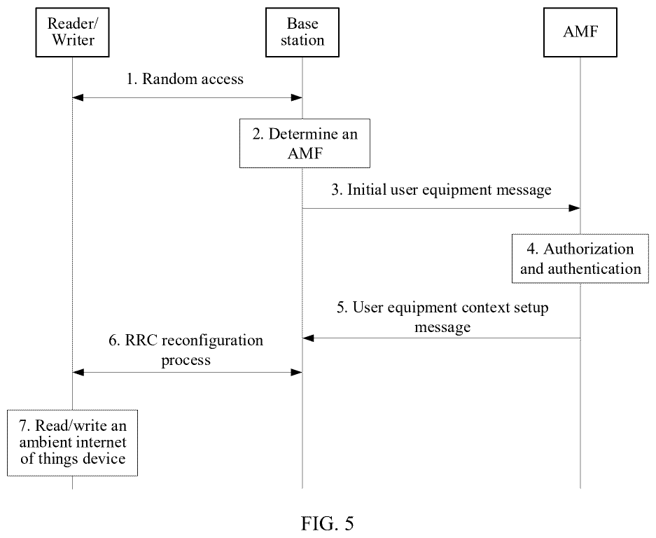

This embodiment mainly describes a reader/writer authorization/authentication procedure of “base station-AMF-base station” in a registration procedure. In this embodiment, in an initial access process of a reader/writer, a base station initiates an authorization/authentication procedure for a reader/writer based on a reader/writer instruction. As shown in FIG. 5, the procedure includes the following steps:
Step 1: In a process of accessing the base station, the reader/writer indicates an identity of being a reader/writer to the base station. For example, as shown in FIG. 5, in a random access process, the reader/writer indicates the identity of being a reader/writer to the base station.
Step 2: After receiving a reader/writer identity indication sent by the reader/writer, the base station determines an AMF that supports authentication and authentication on the reader/writer.
Step 3: The base station sends authorization (or referred to as authentication) and authentication request information (corresponding to the first information above) about the reader/writer to the AMF, where the information may be included in an N2 initial user equipment message (N2 INITIAL UE MESSAGE).
Step 4: After receiving an authorization and authentication request for the reader/writer, the AMF determines whether to allow the reader/writer to access a network, that is, performs an authorization and authentication process, and generates response information, including:
(1) whether the reader/writer is authorized to perform an operation on an ambient internet of things device;
(2) a list of types of operations that the reader/writer is authorized to perform on the ambient internet of things device, including, for example, inventory, read, lock/unlock, write, erase, and kill to be performed on the ambient IoT device; and
(3) a type of a target ambient internet of things device that the reader/writer is allowed to perform an operation on.

Optionally, if the AMF permits the reader/writer to perform a related read/write operation, a transmission channel used for data information related to the ambient internet of things device is established between the reader and a core network.
Step 5: The AMF sends the response information to the base station, where the response information may be carried in a user equipment context setup (UE CONTEXT SETUP) message.
Step 6: After receiving the response information, if the base station determines, based on the response information, that the reader/writer is allowed to perform an operation on the ambient internet of things device, the base station may configure a wireless resource configuration and a transmission configuration of the reader/writer by using an RRC reconfiguration process. The wireless resource is used for wireless transmission between the reader/writer and the ambient internet of things device. The transmission configuration is used to transmit data and information about the ambient internet of things device between the reader/writer, the base station, and the core network.
Step 7: The reader/writer may perform a read/write operation on the ambient internet of things device.

### Embodiment 2

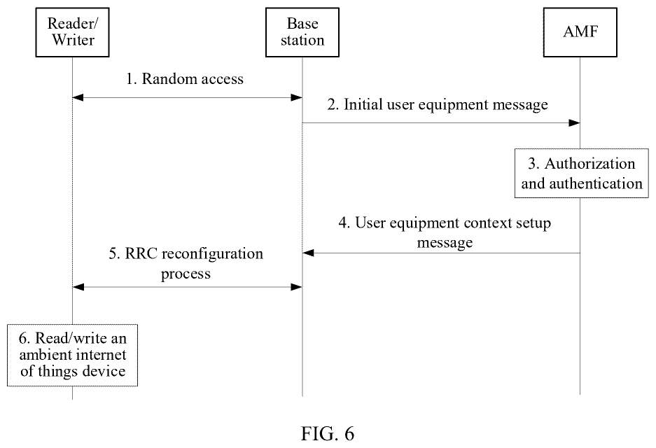

This embodiment mainly describes a procedure of performing, by “AMF-base station”, authorization and authentication on a reader/writer in a registration process. An AMF initiates a procedure of performing authorization and authentication on the reader/writer. As shown in FIG. 6, a process of authorization and authentication performed during registration of the reader/writer is as follows:
Step 1: The reader/writer initiates a wireless access procedure to a base station as common user equipment (UE) to establish a wireless connection. Reference may be made to the random access process in FIG. 6.
Step 2: The base station sends an initial user equipment message (Initial UE message) to the AMF to perform registration of the UE.
Step 3: After receiving the initial UE message, the AMF performs authorization and authentication on the UE, and if it is determined that the UE can be used as a reader/writer that can perform a read/write operation on an ambient internet of things device, the AMF sends authorization information to the UE, where the authorization information may be used to indicate that the UE can be used as a reader/writer. The authorization information may be included in a user equipment context setup (UE CONTEXT SETUP) message or another message, or sent to the base station as a new message. For the authorization information indicating that the UE can be used as a reader/writer, reference may be made to content of the response information in Embodiment 1.
Step 4: The AMF sends the authorization information to the base station, where the authorization information may be carried in a user equipment context setup (UE CONTEXT SETUP) message.
Step 5: After receiving the response information, if the base station determines, based on the response information, that the reader/writer is allowed to perform an operation on the ambient internet of things device, the base station may configure a wireless resource configuration and a transmission configuration of the reader/writer by using an RRC reconfiguration process. The wireless resource is used for wireless transmission between the reader/writer and the ambient internet of things device. The transmission configuration is used to transmit data and information about the ambient internet of things device between the reader/writer, the base station, and a core network.
Step 6: The reader/writer may perform a read/write operation on the ambient internet of things device.

### Embodiment 3

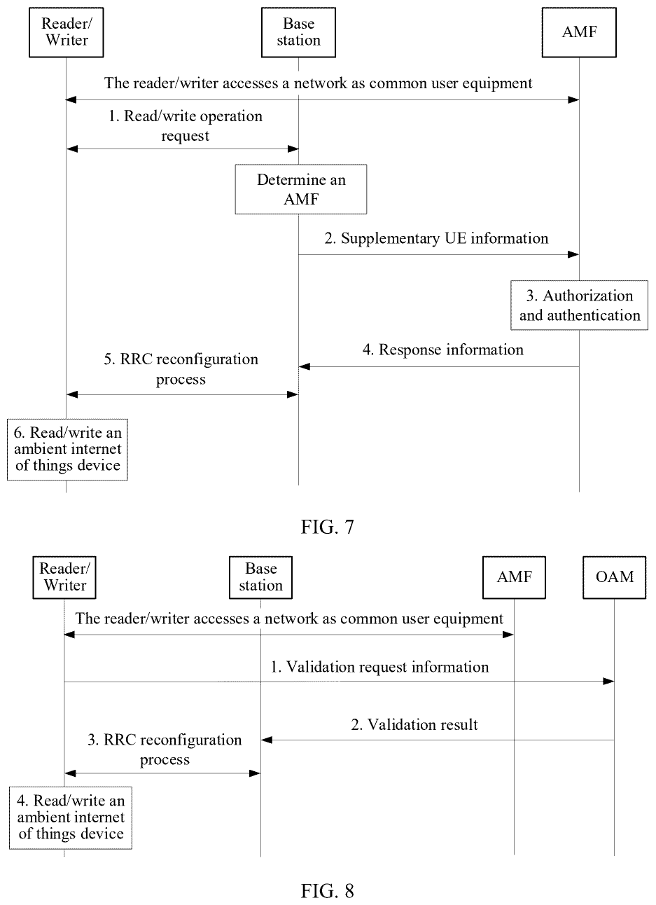

This embodiment mainly describes a procedure of performing authorization and authentication on a reader/writer based on a supplementary authentication message, where a base station initiates a supplementary authorization and authentication procedure for the reader/writer. After the reader/writer has accessed a network as common user equipment (that is, the reader/writer has been authenticated by an AMF as common UE), as shown in FIG. 7, a supplementary authorization or authentication procedure for the reader/writer is performed by using the following steps:
Step 1: The reader/writer sends a read/write operation request (refer to the third information above) to a base station by using a radio resource control (RRC) message, where the read/write operation request may be included in a sensor user interface (SUI) or user assistance information (UAI) message, or a new RRC message may be defined to be used to send the read/write operation request. The read/write operation request may be an explicit request or an implicit request, for example, may include at least one of the following:
(1) The implicit request includes: reporting, to the base station, capability information of the reader/writer about reading/writing an ambient internet of things device, including operations such as inventory, read, write, erase, and kill of the reader/writer mentioned above.
(2) The implicit request includes: reporting identifier information of the reader/writer to the base station.
(3) The implicit request includes: requesting, from the base station, to configure wireless resource information used to perform an operation on the ambient internet of things device.
(4) The explicit request includes: requesting the base station to perform an operation on the ambient internet of things device, including information (for example, a type parameter) of a target ambient internet of things device, a read/write operation type list, and the like.
Step 2: After receiving the foregoing read/write operation request, the base station determines an AMF that supports authorization and authentication for the reader/writer, and sends supplementary UE information to the AMF, where the supplementary UE information includes a request for performing authorization and authentication on the reader/writer, and the request includes at least one of the following: the identifier information of the reader/writer; and a type of a requested operation on the ambient internet of things device. The type of the operation includes operation types such as inventory, read, write, lock/unlock, erase, and kill of the reader/writer mentioned above.
Step 3: After receiving the foregoing request, the AMF determines whether to allow the reader/writer to perform the requested operation, and generates response information. The response information includes content mentioned in step 4 in Embodiment 1.
Step 4: The AMF sends the response information to the base station.
Step 5: After receiving the response information, if the base station determines, based on the response information, that the reader/writer is allowed to perform an operation on the ambient internet of things device, the base station may configure a wireless resource configuration and a transmission configuration of the reader/writer by using an RRC reconfiguration process. The wireless resource is used for wireless transmission between the reader/writer and the ambient internet of things device. The transmission configuration is used to transmit data and information about the ambient internet of things device between the reader/writer, the base station, and a core network, and is used for transmission quality management.
Step 6: The reader/writer may perform a read/write operation on the ambient internet of things device.

### Embodiment 4

This embodiment mainly describes an OAM-based validation (or referred to as authorization and authentication) procedure for a reader/writer. In the OAM-based authorization and authentication procedure for the reader/writer, when the reader/writer needs to use a reader/writer function after accessing a network as common user equipment, as shown in FIG. 8, a reading/writing function authorization and authentication procedure may be initiated.
Step 1: The reader/writer sends validation (validation) request information about the reader/writer to a base station, where the validation request information includes the information mentioned in step 1 in Embodiment 3. Optionally, the validation request information may include a container used to transmit OAM information. After receiving the validation request information, the base station forwards the OAM information carried in the validation request information to an OAM device.
Step 2: After receiving the validation request information of the reader/writer, the OAM device determines a validation result for the reader/writer based on information carried in the validation request information, where the validation result includes at least one of the information mentioned in step 4 in Embodiment 1, and sends the validation result to the base station.
Step 3: After receiving the validation result of the reader/writer, if the base station acknowledges that validation on the reader/writer succeeds, the base station may configure a wireless resource configuration and a transmission configuration of the reader/writer by using an RRC reconfiguration process. The wireless resource is used for wireless transmission between the reader/writer and an ambient internet of things device. The transmission configuration is used to transmit data and information about the ambient internet of things device between the reader/writer, the base station, and a core network.
Step 4: The reader/writer may perform a read/write operation on the ambient internet of things device.

The reader/writer used to perform an operation on the ambient internet of things device that is described in the embodiments of this application may be integrated into an authorization and authentication process in a 3GPP wireless communication system, including a 4G-LTE system, a 5G-NR system, and a future 6G wireless communication system.

The method for managing a reader/writer provided in the embodiments of this application may be performed by an apparatus for managing a reader/writer. In the embodiments of this application, an example in which an apparatus for managing a reader/writer performs the method for managing a reader/writer is used to describe the apparatus for managing a reader/writer provided in the embodiments of this application.

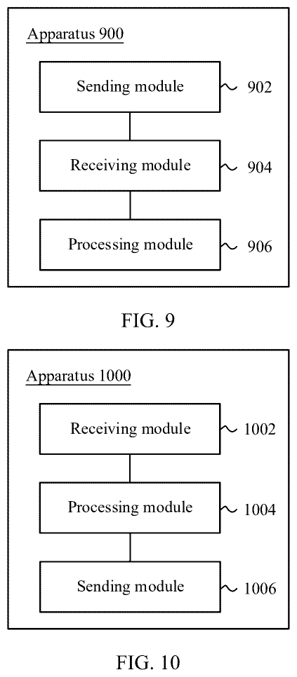

FIG. 9 is a schematic diagram of a structure of an apparatus for managing a reader/writer according to an embodiment of this application. The apparatus may correspond to an access network device in another embodiment. As shown in FIG. 9, the apparatus 900 includes the following modules:
a sending module 902, configured to send first information to an authorization device, where the first information is used to request to perform an authorization and/or authentication operation on a first reader/writer, and the first reader/writer includes a reader/writer of an ambient internet of things device;
a receiving module 904, configured to receive response information of the first information; and
a processing module 906, configured to: in a case that the response information indicates that authorization and/or authentication on the first reader/writer succeed, perform a first operation related to the first reader/writer.

The apparatus for managing a reader/writer provided in this embodiment of this application sends the first information to the authorization device to request to perform the authorization and/or authentication operation on the first reader/writer, where the first reader/writer includes the reader/writer of the ambient internet of things device; receives the response information of the first information; and in a case that the response information indicates that authorization and/or authentication on the first reader/writer succeed, performs the first operation related to the first reader/writer. In this embodiment of this application, it can be ensured that only an authorized and authenticated reader/writer can perform a read/write operation on the ambient internet of things device, so that a reader/writer in a 3GPP network can perform an authorized read/write operation on the ambient internet of things device, thereby improving security performance of the ambient internet of things device.

Optionally, in an embodiment, the processing module 906 is configured to configure a wireless resource configuration and/or a transmission configuration of the first reader/writer, where the wireless resource configuration is used for wireless transmission between the first reader/writer and the ambient internet of things device, the transmission configuration is used for data transmission between the first reader/writer, the apparatus, and a core network device, and the data is related to the ambient internet of things device.

Optionally, in an embodiment, the response information includes at least one of the following: (1) whether the first reader/writer is authorized to perform an operation on the ambient internet of things device; (2) a type of an operation that the first reader/writer is authorized to perform on the ambient internet of things device; and (3) a type of a target ambient internet of things device that the first reader/writer is allowed to perform an operation on.

Optionally, in an embodiment, the receiving module 904 is further configured to receive second information from the first reader/writer, where the second information includes a reader/writer identity indication of the first reader/writer; and the processing module 906 is further configured to determine an AMF that supports authentication and authentication on the reader/writer, where the authorization device includes the AMF.

Optionally, in an embodiment, the sending module 902 is further configured to establish a wireless connection to the first reader/writer based on a wireless access procedure initiated by the first reader/writer, where the first information is carried in a first message, and the first message is a message in a registration process of the first reader/writer.

Optionally, in an embodiment, the first message includes an initial user equipment message.

Optionally, in an embodiment, the response information is carried in a user equipment context setup message.

Optionally, in an embodiment, the receiving module 904 is further configured to receive third information from the first reader/writer, where the third information is used for at least one of the following: (1) reporting capability information of reading/writing the ambient internet of things device; (2) reporting identifier information of the first reader/writer; (3) requesting to configure a wireless resource configuration used for performing an operation on the ambient internet of things device; and (4) requesting to perform an operation on the ambient internet of things device.

Optionally, in an embodiment, the first information includes at least one of the following: (1) the identifier information of the first reader/writer; and (2) a type of an operation requested to perform on the ambient internet of things device.

Optionally, in an embodiment, the authorization device includes an AMF, or the authorization device includes an OAM device.

For the apparatus 900 in this embodiment of this application, reference may be made to the procedure corresponding to the method 200 in the embodiments of this application. In addition, the units/modules in the apparatus 900 and other operations and/or functions described above are separately intended to implement the corresponding procedure in the method 200, and a same or equivalent technical effect can be achieved. For brevity, details are not described herein again.

FIG. 10 is a schematic diagram of a structure of an apparatus for managing a reader/writer according to an embodiment of this application. The apparatus may correspond to an authorization device in another embodiment. As shown in FIG. 10, the apparatus 1000 includes the following modules:
a receiving module 1002, configured to receive first information from an access network device, where the first information is used to request to perform an authorization and/or authentication operation on a first reader/writer, and the first reader/writer includes a reader/writer of an ambient internet of things device;
a processing module 1004, configured to: perform the authorization and/or authentication operation on the first reader/writer based on the first information, and generate response information; and
a sending module 1006, configured to send the response information to the access network device.

The apparatus for managing a reader/writer provided in this embodiment of this application receives the first information from the access network device, where the first information is used to request to perform the authorization and/or authentication operation on the first reader/writer, and the first reader/writer includes the reader/writer of the ambient internet of things device; and performs the authorization and/or authentication operation on the first reader/writer based on the first information, generates the response information, and sends the response information to the access network device. In this embodiment of this application, it can be ensured that only an authorized and authenticated reader/writer can perform a read/write operation on the ambient internet of things device, so that a reader/writer in a 3GPP network can perform an authorized read/write operation on the ambient internet of things device, thereby improving security performance of the ambient internet of things device.

Optionally, in an embodiment, the response information includes at least one of the following: (1) whether the first reader/writer is authorized to perform an operation on the ambient internet of things device; (2) a type of an operation that the first reader/writer is authorized to perform on the ambient internet of things device; and (3) a type of a target ambient internet of things device that the first reader/writer is allowed to perform an operation on.

Optionally, in an embodiment, the first information includes at least one of the following: (1) identifier information of the first reader/writer; and (2) a type of an operation requested to perform on the ambient internet of things device.

Optionally, in an embodiment, the apparatus includes an AMF, or the apparatus includes an OAM device.

For the apparatus 1000 in this embodiment of this application, reference may be made to the procedure corresponding to the method 300 in the embodiments of this application. In addition, the units/modules in the apparatus 1000 and other operations and/or functions described above are separately intended to implement the corresponding procedure in the method 300, and a same or equivalent technical effect can be achieved. For brevity, details are not described herein again.

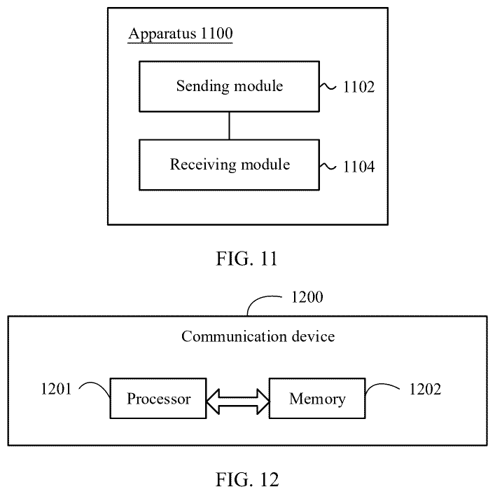

FIG. 11 is a schematic diagram of a structure of an apparatus for managing a reader/writer according to an embodiment of this application. The apparatus may correspond to a reader/writer (for example, a first reader/writer) in another embodiment. As shown in FIG. 11, the apparatus 1100 includes the following module:
a sending module 1102, configured to send third information to an access network device, where the third information is used for at least one of the following: reporting capability information of reading/writing an ambient internet of things device; reporting identifier information of the apparatus; requesting to configure a wireless resource configuration used for performing an operation on the ambient internet of things device; and requesting to perform an operation on the ambient internet of things device.

The apparatus for managing a reader/writer provided in this embodiment of this application sends the third information to the access network device, where the third information is used for at least one of the following: reporting the capability information of reading/writing the ambient internet of things device; reporting the identifier information of the first reader/writer; requesting to configure the wireless resource configuration used for performing an operation on the ambient internet of things device; and requesting to perform an operation on the ambient internet of things device. In this embodiment of this application, only an authorized and authenticated reader/writer can perform a read/write operation on the ambient internet of things device, so that a reader/writer in a 3GPP network can perform an authorized read/write operation on the ambient internet of things device, thereby improving security performance of the ambient internet of things device.

Optionally, in an embodiment, the apparatus further includes a receiving module 1104, configured to receive a wireless resource configuration and/or a transmission configuration, where the wireless resource configuration is used for wireless transmission between the apparatus and the ambient internet of things device, the transmission configuration is used for data transmission between the apparatus, the access network device, and a core network device, and the data is related to the ambient internet of things device.

For the apparatus 1100 in this embodiment of this application, reference may be made to the procedure corresponding to the method 400 in the embodiments of this application. In addition, the units/modules in the apparatus 1100 and other operations and/or functions described above are separately intended to implement the corresponding procedure in the method 400, and a same or equivalent technical effect can be achieved. For brevity, details are not described herein again.

The apparatus for managing a reader/writer in this embodiment of this application may be an electronic device, for example, an electronic device with an operating system, or may be a component in an electronic device, for example, an integrated circuit or a chip. The electronic device may be a terminal, or may be another device different from a terminal. For example, the terminal may include but is not limited to the foregoing listed types of the terminal 11. The another device may be a server, a network attached storage (NAS), or the like. This is not specifically limited in this embodiment of this application.

The apparatus for managing a reader/writer provided in this embodiment of this application can implement the processes implemented in the method embodiments of FIG. 2 to FIG. 8, and a same technical effect is achieved. To avoid repetition, details are not described herein again.

Optionally, as shown in FIG. 12, an embodiment of this application further provides a communication device 1200, including a processor 1201 and a memory 1202, and the memory 1202 stores a program or instructions capable of running on the processor 1201. For example, when the communication device 1200 is a terminal, the program or the instructions are executed by the processor 1201 to implement the steps in the foregoing embodiment of the method for managing a reader/writer, and a same technical effect can be achieved. When the communication device 1200 is a network side device, the program or the instructions are executed by the processor 1201 to implement the steps in the foregoing embodiment of the method for managing a reader/writer, and a same technical effect can be achieved. To avoid repetition, details are not described herein again.

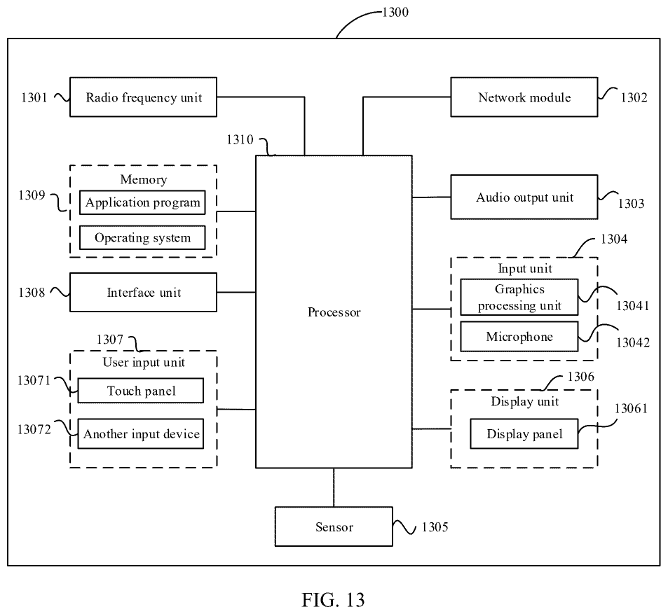

An embodiment of this application further provides a terminal, including a processor and a communication interface. The communication interface is configured to send third information to an access network device, where the third information is used for at least one of the following: reporting capability information of reading/writing an ambient internet of things device; reporting identifier information of the terminal; requesting to configure a wireless resource configuration used for performing an operation on the ambient internet of things device; and requesting to perform an operation on the ambient internet of things device. This terminal embodiment corresponds to the foregoing method embodiment on the terminal side. Each implementation process and implementation of the foregoing method embodiment may be applied to this terminal embodiment, and a same technical effect can be achieved. Specifically, FIG. 13 is a schematic diagram of a hardware structure of a terminal for implementing an embodiment of this application.

The terminal 1300 includes but is not limited to at least some components in a radio frequency unit 1301, a network module 1302, an audio output unit 1303, an input unit 1304, a sensor 1305, a display unit 1306, a user input unit 1307, an interface unit 1308, a memory 1309, a processor 1310, and the like.

A person skilled in the art may understand that the terminal 1300 may further include a power supply (for example, a battery) that supplies power to each component. The power supply may be logically connected to the processor 1310 by using a power management system, to implement functions such as charging management, discharging management, and power consumption management through the power management system. The structure of the terminal shown in FIG. 13 does not constitute a limitation on the terminal. The terminal may include more or fewer components than those shown in the figure, or combine some components, or have different component arrangements. Details are not described herein again.

It should be understood that in this embodiment of this application, the input unit 1304 may include a graphics processing unit (GPU) 13041 and a microphone 13042. The graphics processing unit 13041 processes image data of a still picture or a video obtained by an image capture apparatus (for example, a camera) in a video capture mode or an image capture mode. The display unit 1306 may include a display panel 13061, and the display panel 13061 may be configured in a form of a liquid crystal display, an organic light-emitting diode, or the like. The user input unit 1307 includes at least one of a touch panel 13071 or another input device 13072. The touch panel 13071 is also referred to as a touchscreen. The touch panel 13071 may include two parts: a touch detection apparatus and a touch controller. The another input device 13072 may include but is not limited to a physical keyboard, a function key (such as a volume control key or an on/off key), a trackball, a mouse, and an operating lever. Details are not described herein again.

In this embodiment of this application, after receiving downlink data from a network side device, the radio frequency unit 1301 may transmit the downlink data to the processor 1310 for processing. In addition, the radio frequency unit 1301 may send uplink data to a network side device. Generally, the radio frequency unit 1301 includes but is not limited to an antenna, an amplifier, a transceiver, a coupler, a low-noise amplifier, a duplexer, and the like.

The memory 1309 may be configured to store a software program or instructions and various types of data. The memory 1309 may mainly include a first storage area for storing a program or instructions and a second storage area for storing data. The first storage area may store an operating system, an application program or instructions required by at least one function (for example, a sound play function or an image play function), and the like. In addition, the memory 1309 may include a volatile memory or a non-volatile memory, or the memory 1309 may include both a volatile memory and a non-volatile memory. The nonvolatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synch link DRAM, SLDRAM), and a direct rambus random access memory (Direct Rambus RAM, DRRAM). The memory 1309 in this embodiment of this application includes but is not limited to these memories and any other suitable type of memory.

The processor 1310 may include one or more processing units. Optionally, the processor 1310 is integrated with an application processor and a modem processor. The application processor mainly processes operations related to an operating system, a user interface, an application program, and the like. The modem processor, for example, a baseband processor, mainly processes a wireless communication signal. It may be understood that, the foregoing modem processor may not be integrated into the processor 1310.

The radio frequency unit 1301 may be configured to send third information to an access network device, where the third information is used for at least one of the following: reporting capability information of reading/writing an ambient internet of things device; reporting identifier information of the terminal; requesting to configure a wireless resource configuration used for performing an operation on the ambient internet of things device; and requesting to perform an operation on the ambient internet of things device.

In this embodiment of this application, it can be ensured that only an authorized and authenticated reader/writer can perform a read/write operation on the ambient internet of things device, so that a reader/writer in a 3GPP network can perform an authorized read/write operation on the ambient internet of things device, thereby improving security performance of the ambient internet of things device.

The terminal 1300 provided in this embodiment of this application may further implement various processes in the foregoing embodiment of the method for managing a reader/writer, and a same technical effect can be achieved. To avoid repetition, details are not described herein again.

An embodiment of this application further provides a network side device, including a processor and a communication interface. The communication interface is configured to send first information to an authorization device, where the first information is used to request to perform an authorization and/or authentication operation on a first reader/writer, and the first reader/writer includes a reader/writer of an ambient internet of things device; the communication interface is configured to receive response information of the first information; and the processor is configured to: in a case that the response information indicates that authorization and/or authentication on the first reader/writer succeed, perform a first operation related to the first reader/writer. Alternatively, the communication interface is configured to receive first information from an access network device, where the first information is used to request to perform an authorization and/or authentication operation on a first reader/writer, and the first reader/writer includes a reader/writer of an ambient internet of things device; the processor is configured to: perform the authorization and/or authentication operation on the first reader/writer based on the first information, and generate response information; and the communication interface is configured to send the response information to the access network device.

This network side device embodiment corresponds to the foregoing method embodiment for the network side device, and each implementation process and implementation of the foregoing method embodiment can be applied to this network side device embodiment, and a same technical effect can be achieved.

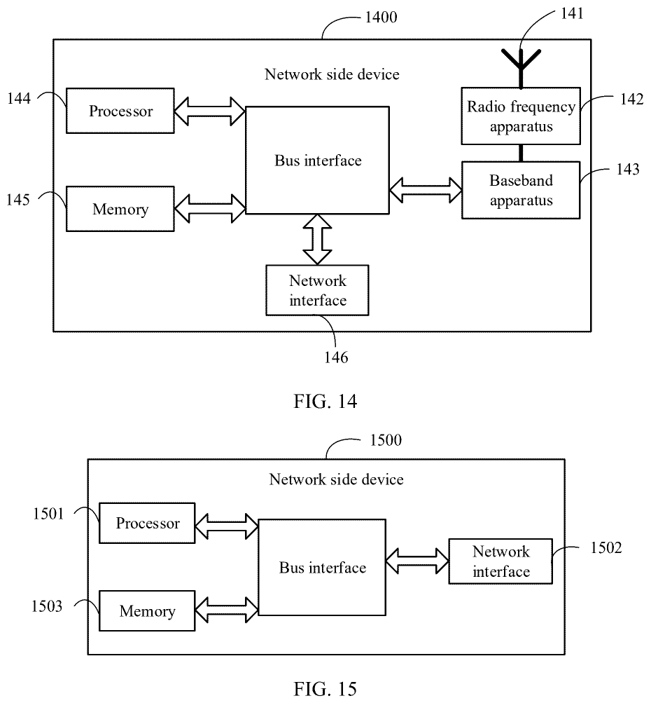

Specifically, an embodiment of this application further provides a network side device (which may be an access network device). As shown in FIG. 14, the network side device 1400 includes an antenna 141, a radio frequency apparatus 142, a baseband apparatus 143, a processor 144, and a memory 145. The antenna 141 is connected to the radio frequency apparatus 142. In an uplink direction, the radio frequency apparatus 142 receives information through the antenna 141, and sends the received information to the baseband apparatus 143 for processing. In a downlink direction, the baseband apparatus 143 processes to-be-sent information, and sends processed information to the radio frequency apparatus 142. After processing the received information, the radio frequency apparatus 142 sends processed information through the antenna 141.

The method performed by the network side device in the foregoing embodiment may be implemented in the baseband apparatus 143. The baseband apparatus 143 includes a baseband processor.

For example, the baseband apparatus 143 may include at least one baseband board. A plurality of chips are disposed on the baseband board. As shown in FIG. 14, one of the chips is, for example, the baseband processor, and is connected to the memory 145 by using a bus interface, to invoke a program in the memory 145 to perform an operation of a network device shown in the foregoing method embodiment.

The network side device may further include a network interface 146. For example, the interface is a common public radio interface (CPRI).

Specifically, the network side device 1400 in this embodiment of the present invention further includes instructions or a program that is stored in the memory 145 and that can be run on the processor 144. The processor 144 invokes the instructions or the program in the memory 145 to perform the method performed by the modules shown in FIG. 9 or FIG. 10, and a same technical effect is achieved. To avoid repetition, details are not described herein again.

Specifically, an embodiment of this application further provides a network side device (which may be a core network device). As shown in FIG. 15, the network side device 1500 includes a processor 1501, a network interface 1502, and a memory 1503. The network interface 1502 is, for example, a common public radio interface (common public radio interface, CPRI).

Specifically, the network side device 1500 in this embodiment of the present invention further includes instructions or a program that is stored in the memory 1503 and that can be run on the processor 1501. The processor 1501 invokes the instructions or the program in the memory 1503 to perform the method performed by the modules shown in FIG. 9 or FIG. 10, and a same technical effect is achieved. To avoid repetition, details are not described herein again.

An embodiment of this application further provides a readable storage medium. The readable storage medium stores a program or instructions. When the program or the instructions are executed by a processor, the processes in the foregoing embodiment of the method for managing a reader/writer, and a same technical effect can be achieved. To avoid repetition, details are not described herein again.

The processor is a processor in the terminal in the foregoing embodiments. The readable storage medium may be non-volatile, or may be non-transitory. The readable storage medium includes a computer-readable storage medium, such as a computer read-only memory ROM, a random access memory RAM, a magnetic disk, or an optical disc.

An embodiment of this application further provides a chip. The chip includes a processor and a communication interface. The communication interface is coupled to the processor. The processor is configured to run a program or instructions to implement the processes in the foregoing embodiments of the method for managing a reader/writer, and a same technical effect can be achieved. To avoid repetition, details are not described herein again.

It should be understood that, the chip mentioned in this embodiment of this application may also be referred to as a system-level chip, a system chip, a chip system, or a system on chip.

An embodiment of this application further provides a computer program/program product. The computer program/program product is stored in a storage medium. The computer program/program product is executed by at least one processor to implement the processes the foregoing embodiments of the method for managing a reader/writer, and a same technical effect can be achieved. To avoid repetition, details are not described herein again.

An embodiment of this application further provides a system for managing a reader/writer, including a terminal and a network side device. The terminal may be configured to perform the steps of the foregoing method for managing a reader/writer, and the network side device may be configured to perform the steps of the foregoing method for managing a reader/writer.

It should be noted that in this specification, the term “comprise”, “include”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. Without more constraints, an element preceded by “includes a . . . ” does not preclude the existence of additional identical elements in the process, method, article, or apparatus that includes the element. In addition, it should be noted that, the scope of the method and apparatus in the implementations of this application is not limited to performing functions in a sequence shown or discussed, and may further include performing functions in a basically simultaneous manner or in a reverse order based on the functions involved. For example, the described method may be performed in an order different from the order described, and various steps may be added, omitted, or combined. In addition, features described with reference to some examples may be combined in other examples.

According to the foregoing descriptions of the implementations, a person skilled in the art may clearly understand that the method in the foregoing embodiments may be implemented by software and a necessary general-purpose hardware platform, or certainly may be implemented by hardware. However, in many cases, the former is a better implementation. Based on such an understanding, the technical solutions of this application essentially or the part contributing to the prior art may be implemented in a form of a computer software product. The computer software product is stored in a storage medium (for example, a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing specific embodiments. The foregoing specific embodiments are merely illustrative rather than restrictive. Inspired by this application, a person of ordinary skill in the art may develop many other manners without departing from principles of this application and the protection scope of the claims, and all such manners fall within the protection scope of this application.

1. A method for managing a reader/writer, comprising:
sending, by an access network device, first information to an authorization device, wherein the first information is used to request to perform an authorization or authentication operation on a first reader/writer, and the first reader/writer comprises a reader/writer of an ambient internet of things device;
receiving, by the access network device, response information of the first information; and
in a case that the response information indicates that authorization or authentication on the first reader/writer succeed, performing, by the access network device, a first operation related to the first reader/writer.

2. The method according to claim 1, wherein the performing, by the access network device, a first operation related to the first reader/writer comprises:
configuring, by the access network device, a wireless resource configuration and/or a transmission configuration of the first reader/writer; wherein
the wireless resource configuration is used for wireless transmission between the first reader/writer and the ambient internet of things device; and
the transmission configuration is used for data transmission between the first reader/writer, the access network device, and a core network device, and the data is related to the ambient internet of things device.

3. The method according to claim 1, wherein the response information comprises at least one of the following:
whether the first reader/writer is authorized to perform an operation on the ambient internet of things device;
a type of an operation that the first reader/writer is authorized to perform on the ambient internet of things device; and
a type of a target ambient internet of things device that the first reader/writer is allowed to perform an operation on.

4. The method according to claim 1, wherein before the sending, by an access network device, first information to an authorization device, the method further comprises:
receiving, by the access network device, second information from the first reader/writer, wherein the second information comprises a reader/writer identity indication of the first reader/writer; and
determining, by the access network device, an access and mobility management function AMF that supports authentication and authentication on the reader/writer, and the authorization device comprises the AMF.

5. The method according to claim 1, wherein before the sending, by an access network device, first information to an authorization device, the method further comprises:
establishing, by the access network device, a wireless connection to the first reader/writer based on a wireless access procedure initiated by the first reader/writer; wherein
the first information is carried in a first message, and the first message is a message in a registration process of the first reader/writer.

6. The method according to claim 5, wherein the first message comprises an initial user equipment message.

7. The method according to claim 1, wherein the response information is carried in a user equipment context setup message.

8. The method according to claim 1, wherein before the sending, by an access network device, first information to an authorization device, the method further comprises: receiving, by the access network device, third information from the first reader/writer, wherein the third information is used for at least one of the following:
reporting capability information of reading/writing the ambient internet of things device;
reporting identifier information of the first reader/writer;
requesting to configure a wireless resource configuration used for performing an operation on the ambient internet of things device; and
requesting to perform an operation on the ambient internet of things device.

9. The method according to claim 8, wherein the first information comprises at least one of the following:
the identifier information of the first reader/writer; and
a type of an operation that is requested to perform on the ambient internet of things device.

10. The method according to claim 8, wherein
the authorization device comprises an AMF; or
the authorization device comprises an operation administration and maintenance OAM device.

11. A method for managing a reader/writer, comprising:
receiving, by an authorization device, first information from an access network device, wherein the first information is used to request to perform an authorization and/or authentication operation on a first reader/writer, and the first reader/writer comprises a reader/writer of an ambient internet of things device;
performing, by the authorization device, the authorization and/or authentication operation on the first reader/writer based on the first information, and generating response information; and
sending, by the authorization device, the response information to the access network device.

12. The method according to claim 11, wherein the response information comprises at least one of the following:
whether the first reader/writer is authorized to perform an operation on the ambient internet of things device;
a type of an operation that the first reader/writer is authorized to perform on the ambient internet of things device; and
a type of a target ambient internet of things device that the first reader/writer is allowed to perform an operation on.

13. The method according to claim 11, wherein the first information comprises at least one of the following:
identifier information of the first reader/writer; and
a type of an operation that is requested to perform on the ambient internet of things device.

14. The method according to claim 11, wherein
the authorization device comprises an AMF; or
the authorization device comprises an OAM device.

15. A method for managing a reader/writer, comprising: sending, by a first reader/writer, third information to an access network device, wherein the third information is used for at least one of the following:
reporting capability information of reading/writing an ambient internet of things device;
reporting identifier information of the first reader/writer;
requesting to configure a wireless resource configuration used for performing an operation on the ambient internet of things device; and
requesting to perform an operation on the ambient internet of things device.

16. The method according to claim 15, wherein the method further comprises: receiving, by the first reader/writer, a wireless resource configuration and/or a transmission configuration; wherein
the wireless resource configuration is used for wireless transmission between the first reader/writer and the ambient internet of things device; and
the transmission configuration is used for data transmission between the first reader/writer, the access network device, and a core network device, and the data is related to the ambient internet of things device.

17. A terminal, comprising a processor and a memory, wherein the memory stores a program or instructions capable of running on the processor, and when the program or the instructions are executed by the processor, the steps of the method according to claim 15 are implemented.

18. A network side device, comprising a processor and a memory, wherein the memory stores a program or instructions capable of running on the processor, and when the program or the instructions are executed by the processor, the steps of the method according to claim 1 are implemented.

19. A network side device, comprising at least one hardware processor and a memory, wherein the memory stores a program or instructions capable of execution by the at least one hardware processor, and when the program or the instructions are executed by the at least one hardware processor, the method according to claim 11 is implemented.

20. A non-transitory computer-readable storage medium having a program or instructions stored thereon that, when executed by at least one hardware processor, the method according to claim 1 is implemented.
